(19) United States
(12) Patent Application Publication
(10) Pub. No.: US 2010/0038170 A1
(43) Pub. Date: Feb. 18, 2010

(54) Safety Harness With Femoral Vein Protection

(76) Inventor: Marco Einhaus, Wessling (DE)

Correspondence Address: SMITH FROHWEIN TEMPEL GREENLEE BLAHA, LLC, Two Ravinia Drive, Suite 700, ATLANTA, GA, 30346, US

(21) Appl. No.: 12/521,943

(22) PCT Filed: Jan. 2, 2008
(86) PCT No.: PCT/EP2008/000002

§ 371 Date: Sep. 8, 2009

(30) Foreign Application Priority Data
Jan. 2, 2007 (DE) 10 2007 001 017.8

(51) Int. Cl. A62B 35/00

(52) U.S. Cl. 182/3

(57) ABSTRACT

Safety harness for the human body, having two leg harnesses for two human legs, wherein at least one of the leg harnesses has an opening which is arranged in such a way as to keep the vena femoralis at least partially free.

### FIELD OF THE INVENTION

The present invention relates to personal protection equipment against fall, beyond this relates to all harnesses with support and hanging function, comprising safety harnesses with protection of the femoral vein (Vena femoralis) for extending the hanging time until occurrence of the suspension trauma (“Hängetrauma”).

### BACKGROUND OF THE INVENTION

A safety harness is for instance known from US 2005/0045420 A1. This pre-known safety harness comprises a shiftable cushion pad arranged at each of the leg harnesses at the groin region. By the cushion pads, it is intended to reduce the danger of injury which results from a shock absorbing impulse (“Fangstoβ”) impacting on the groin region. For an improved adjustment to the groin region, the pre-known cushion pad is centrally equipped with an integral hinge.

### SHORT SUMMARY OF THE INVENTION

There may be a need for an improved safety harness, particularly one which influences the blood flow in the groin region in a reduced manner.

This need may be met by the safety harness with the features according to the independent patent claim. Further embodiments are specified in the dependent claims.

By the safety harness according to the invention, the following problem of safety harnesses according to the prior art may be reduced. If a person falls into the protection system with conventional safety harnesses, she/he suffers, according to hitherto existing medical knowledge, in about 20 minutes an orthostatic shock, the so-called suspension trauma (“Hängetrauma”).

The safety harnesses according to the invention can for instance be employed in the following fields:
construction, installation, medical and medical technical, parachute, mining, sports climbing, climbing, mobile maintenance platforms for a silo (“Silobefahranlagen”), rescue, saving (for instance cable railway facilities) or aerospace technology and aerospace suits.

By the novel design of a safety harness with a protection for the femoral vein the hanging time may be significantly increased which is so important for the rescue.

The novel design of the safety harness is characterized in that at least one of the leg harnesses has a recess which is arranged in such a manner that the femoralis vein is at least partially kept free (or maintained uncovered).

The safety harness is positioned in the region of the pelvis for instance by two leg harness pads, made of a compressible material, per side so that an adverse effect on the blood flow of the femoral vein in the groin region from an external influence is prevented. The pads can be made of an identical or of a different material.

Due to the anatomy of the human being, the femoral vein is positioned in the central groin region approximately 100 to 200 mm, depending on leg circumference, spaced with regard to the Spina iliaca anterior superior. An ergonomic pad must therefore lead off the harness forces in such a manner via the spinae (iliac spine) and the tuber (tuber ischiadicum) that a sufficiently free back flow to the heart is possible also in a hanging state. For this purpose, the >30 mm thick leg pads are interrupted in the region of the femoral vein over a length of approximately 50 to 150 mm. Particularly, the leg pad has a thickness of 30 mm, preferably 40 mm, particularly preferably 35 mm. The skilled person will select the most appropriate material thickness depending on material, field of application and leg circumference. In other words, it has to be ensured that no compression shall occur starting from the femoral vein in both directions for at least 50 mm.

Due to the thus obtained release in the groin region, an only slightly reduced venous blood back flow is enabled which contributes to the significant increase of the hanging time and therefore reduces the mortality rate prior to the rescue. An orthostatic shock occurs according to the here presented product/device with a significant time delay.

### SHORT DESCRIPTION OF THE FIGURES

FIG. 1 shows an exemplary embodiment of a leg harness according to the invention.

FIG. 2 illustrates a further exemplary embodiment of a safety harness according to the invention with leg harness and chest harness.

FIG. 3 illustrates a photo of an exemplary embodiment.

### DETAILED DESCRIPTION

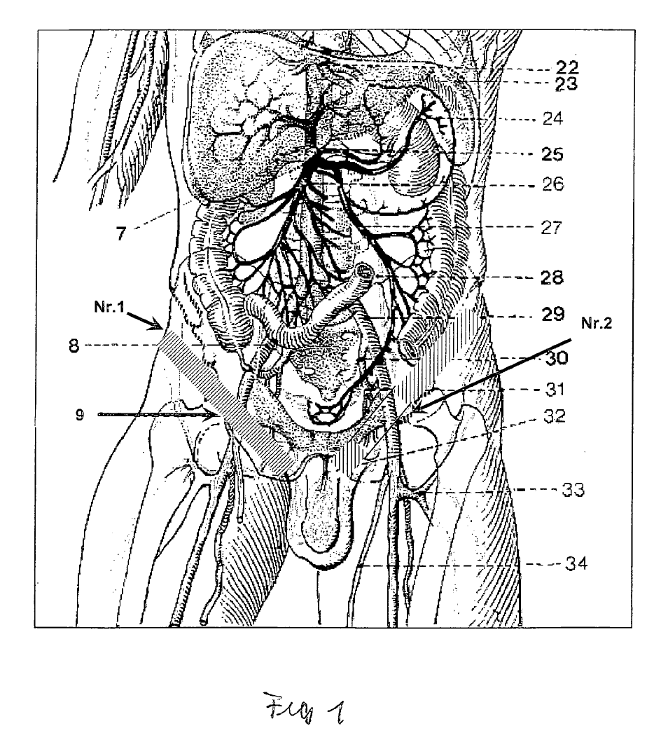

FIG. 1 shows a schematic illustration of an embodiment of a leg harness according to the invention. Particularly, FIG. 1 shows a schematic illustration of a human body with internal organs and the corresponding vein system, wherein the reference numerals 7, 8, 9, 22, 23, 24, 25, 26, 27, 28, 31, 32, 33 and 34 show different organs, veins and arteries. In this connection, the reference numeral 9 denotes the femoral vein. The safety harness for the human body, which safety harness is illustrated in FIG. 1 as hatched areas 1 and 2, comprises two leg harnesses for two human legs, wherein at least one of the leg harnesses has a recess (or an opening) which is located in such a manner that the femoral vein is at least partially kept free. In order to clarify this, the right leg is illustrated in FIG. 1 with a leg harness 1 of a conventional safety harness, whereas the left leg is provided with a leg harness (or leg strap) 2 according to an exemplary embodiment of the invention. In this context, it can be seen that the right leg harness (conventional construction) squeezes the femoral vein 9, whereas the left leg harness according to the invention does not squeeze the femoral vein.

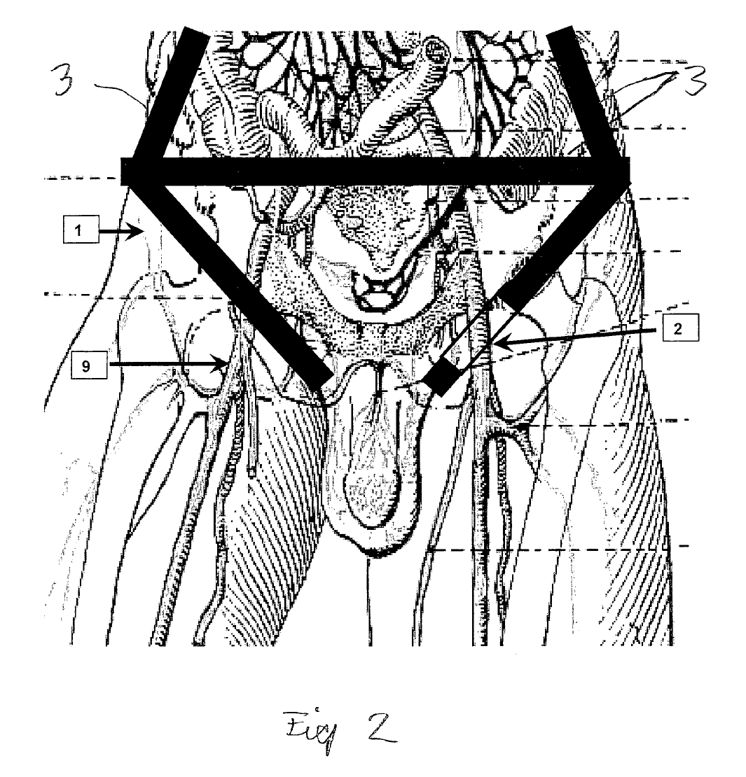

FIG. 2 shows a schematic illustration of a further exemplary embodiment of a safety harness according to the invention with leg harness (or leg strap, “Beingurt”) and chest harness (or chest strap, “Brustgurt”). The basic difference to the embodiment shown in FIG. 1 is that the safety harness additionally comprises a chest harness 3.

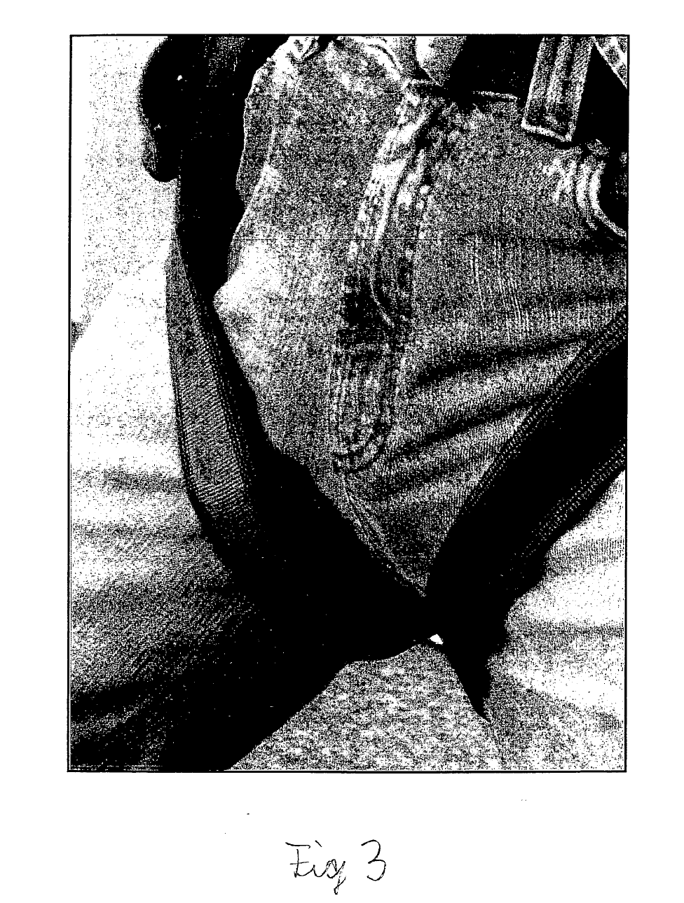

FIG. 3 illustrates a photo of a safety harness at which a recess can be seen at the right leg which recess is formed by two leg pads. A spacing between these two leg pads has the effect that the recess is formed between them which prevents a squeezing of the femoral vein or at least reduces the danger of squeezing.

1. A safety harness for a human body, comprising two leg harnesses for two human legs, wherein at least one of the leg harnesses comprises a recess, the recess arranged in such a manner that the femoral vein is at least partially kept free.

2. The safety harness according to claim 1, wherein both leg harnesses comprise the recess.

3. The safety harness according to claim 1, wherein at least one of the leg harnesses comprises a pad and wherein the pad consists of rubber foam.

4. The safety harness according to claim 3, wherein the pad consists of plastic.

5. The safety harness according to claim 1, wherein the recess is configured in such a manner to maintain a blood flow through the femoral vein even when the human body falls into the safety harness.

6. The safety harness according to claim 1, wherein the recess is at least partially filled with a gel material.

7. The safety harness according to claim 1, wherein the recess is applied to hanging harnesses in the medical field.

8. The safety harness according to claim 1, wherein the recess is applied to one or more of a parachute harness, a sports climbing harness, a silo inspection harness, a rescue harness or a harness in aerospace technology or an aerospace suit.

9. A method of using the safety harness according to claim 1, for increasing the hanging time before occurrence of orthostatic shock and suspension trauma.
